(19) United States
(12) Patent Application Publication
(10) Pub. No.: US 2026/0347261 A1
(43) Pub. Date: Nov. 5, 2026

(54) CERAMIC COMPOSITION AND CERAMIC COMPONENT

(71) Applicant: Niterra Co., Ltd., Nagoya-shi, Aichi (JP)

(72) Inventors: Tomohiro NISHI, Nagoya-shi (JP); Toshiaki KURAHASHI, Nagoya-shi (JP); Jun MOTEKI, Nagoya-shi (JP); Daiki KATO, Nagoya-shi (JP); Tomoko HISHIDA, Nagoya-shi (JP); Motohiko SATO, Nagoya-shi (JP)

(73) Assignee: Niterra Co., Ltd., Nagoya-shi, Aichi (JP)

(21) Appl. No.: 19/487,125

(22) PCT Filed: Nov. 8, 2024
(86) PCT No.: PCT/JP2024/039722

§ 371 Date: Nov. 24, 2025

(30) Foreign Application Priority Data
Mar. 28, 2024 (JP) 2024-053317

(51) Int. Cl. C04B 35/111

(52) U.S. Cl. CPC C04B 35/111; C04B 2235/3217; C04B 2235/3244; C04B 2235/3847; C04B 2235/404; C04B 2235/767; C04B 2235/85

(57) ABSTRACT

Provided is a ceramic composition containing alumina (Al₂O₃) and tungsten carbide (WC). In the ceramic composition, an atomic layer formed of hafnium (Hf) is present at the crystal grain boundary between crystal grains of alumina (Al₂O₃) and crystal grains of tungsten carbide (WC). The atomic layer includes two or more atomic arrangement layers of hafnium.

### TECHNICAL FIELD

The present invention relates to a ceramic composition and to a ceramic component including the composition.

### BACKGROUND ART

Various techniques are disclosed for improving characteristics of a ceramic composition containing alumina (Al₂O₃) as a predominant ingredient. In some techniques, tungsten carbide (WC) is incorporated as an additive into such a ceramic composition containing alumina (Al₂O₃).

For example, Patent Document 1 discloses a ceramic composition containing alumina (Al₂O₃) and tungsten carbide (WC), characterized in that an atomic layer formed of at least one element selected from among a transition metal belonging to Group 4 to 6 in the periodic table, yttrium (Y), scandium (Sc), and a lanthanoid exists at a crystal grain boundary between crystal grains of alumina (Al₂O₃) and crystal grains of tungsten carbide (WC).

### PRIOR ART DOCUMENTS

### Patent Documents

Patent Document 1: Japanese Patent No. 6491363

### SUMMARY OF THE INVENTION

### Problems to be Solved by the Invention

As described above, a variety of techniques have been proposed to improve characteristics of a ceramic composition containing alumina (Al₂O₃) and tungsten carbide (WC).

In one aspect of the present invention, an object of the invention is to further enhance characteristics of a ceramic composition containing alumina and tungsten carbide under high-temperature conditions.

### Means for Solving the Problems

[1]

According to one aspect of the present invention, there is provided a ceramic composition including alumina (Al₂O₃) and tungsten carbide (WC), wherein an atomic layer formed of hafnium (Hf) exists at a crystal grain boundary between crystal grains of alumina (Al₂O₃) and crystal grains of tungsten carbide (WC), and the atomic layer includes two or more atomic arrangement layers of hafnium.

[2]

In the ceramic composition as described in [1] according to one aspect of the present invention, the ceramic composition may have a pore ratio of 0.1% or less, as determined in any one cross-section of the composition.

[3]

In the ceramic composition as described in [1] or [2] according to one aspect of the present invention, the atomic layer at the crystal grain boundary may be formed of a metal crystal phase of hafnium (Hf).

[4]

In the ceramic composition as described in [3] according to one aspect of the present invention, the atomic layer at the crystal grain boundary may be formed of a (210) plane of the metal crystal phase of hafnium (Hf).

[5]

In the ceramic composition as described in [4] according to one aspect of the present invention, the metal crystal phase of hafnium (Hf) is hexagonal, and the atomic layer may be formed of the hexagonal (210) plane having a thickness corresponding to three layers thereof.

[6]

According to another aspect of the present invention, there is provided a ceramic component, including a ceramic composition as recited in any of [1] to [5].

[7]

The ceramic component as described in [6] according to the above aspect of the present invention may be used as any of a gas turbine member, a spray nozzle for use in an artificial satellite, a metal mold for lenses, a sealing material, an aircraft engine member, and a cutting tool.

### Effects of the Invention

According to one aspect of the present invention, there can be provided a ceramic composition exhibiting enhanced characteristics including ductility and flexural strength at high temperature.

### BRIEF DESCRIPTION OF THE DRAWINGS

FIG. 1 is a perspective external view of a ceramic composition according to one embodiment.

FIG. 2 shows a TEM image of a cross-section (cut along the line A-A) of a ceramic composition according to one Example.

FIG. 3 shows HAADF-STEM images of an area around the crystal grain boundary in a ceramic composition according to one Example.

FIG. 4 shows an HAADF-STEM image of an area around the crystal grain boundary in a ceramic composition according to one Example, and a simulation image thereof.

FIG. 5 shows an HAADF-STEM image of an area around the crystal grain boundary in a ceramic composition according to one Example.

FIG. 6 shows an SEM image of a cross-section of the ceramic composition according to one Example, with ingredients thereof being denoted by marking of different colors.

FIG. 7 shows a TEM image of a cross-section of the ceramic composition after application of stress.

FIG. 8 shows an SEM image of a cross-section of the ceramic composition after application of stress, with ingredients thereof being denoted by marking of different colors.

FIG. 9 is a flowchart showing a method for producing a ceramic composition according to one embodiment.

### MODES FOR CARRYING OUT THE INVENTION

With reference to the drawings, an embodiment of the present invention will next be described. In the present embodiment, the ceramic composition will be described, taking a ceramic composition 10 as an example. The ceramic composition 10 is suitably used as a material of a ceramic component included in a device employed under high-temperature conditions (at 1,400 °C or higher). More specifically, the ceramic composition 10 is used as a material of a ceramic component, for example, a gas turbine member, a spray nozzle for use in an artificial satellite, a metal mold for lenses, a sealing material, an aircraft engine member, and a cutting tool.

### (Structure of Ceramic Composition)

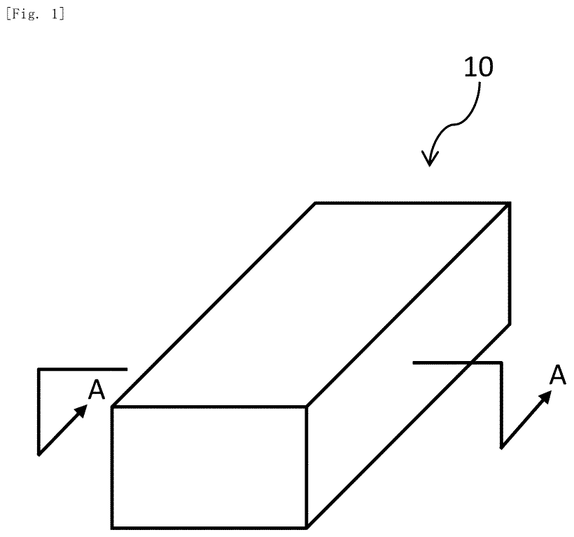

FIG. 1 is a perspective external view of the ceramic composition 10. The ceramic composition 10 contains alumina (Al₂O₃) and tungsten carbide (WC). In the ceramic composition 10, an atomic layer formed of hafnium (Hf) exists at the crystal grain boundary between crystal grains of alumina (Al₂O₃) and those of tungsten carbide (WC). The atomic layer includes two or more atomic arrangement layers.

The atomic layer formed of hafnium (Hf) is yielded by, for example, adding a hafnium compound (e.g., hafnia (HfO₂ )) as a raw material during production of the ceramic composition 10.

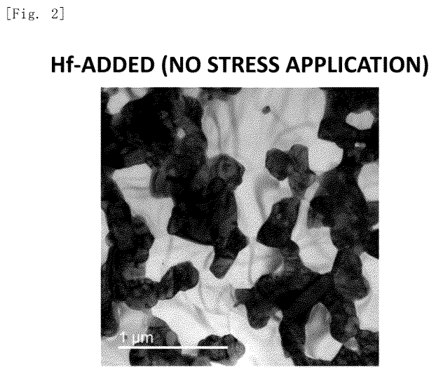

FIG. 2 shows an example of the TEM image of a cross-section of the ceramic composition 10 shown in FIG. 1, the cross-section being cut along line A-A. The TEM image shown in FIG. 2 can be obtained through observation of a sample under a transmission electron microscope. The sample has been prepared through the following procedure.

Firstly, the ceramic composition is cut at a specific position and in a specific direction into a disk plate (φ: 3 mm) by means of a diamond cutter and an ultrasonic disk cutter. The disk plate is thinned by use of 30-μm diamond abrasive paper, to thereby adjust the thickness to less than 100 μm. Subsequently, the thinned disk is subjected to dimple processing by means of a dimpler, to thereby form dimples in the center of the disk, and is further processed by means of a precision ion polishing system (PIPS). The TEM image shown in FIG. 2 is obtained by observing the sample which has been subjected to ion polishing under specific conditions (Ar ion, acceleration voltage: 4.0 kV, and beam radiation angle: ±4°) and a damage layer removal treatment at 1.0 kV for 2 minutes after passage of the sample.

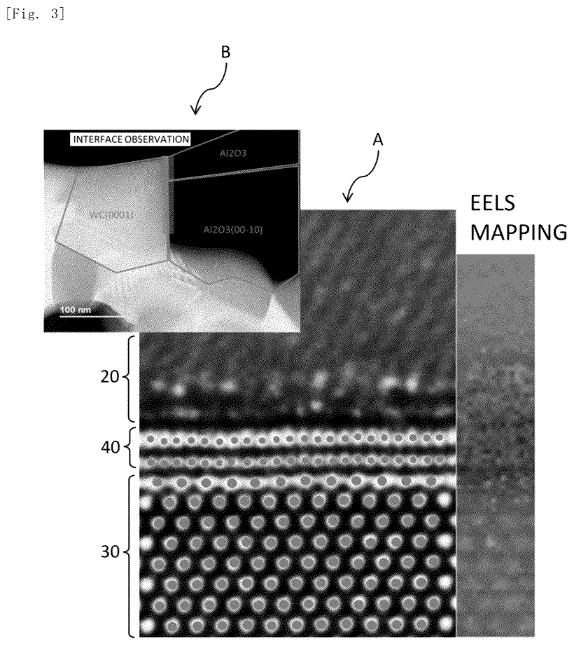

FIG. 3 shows an example of a set of HAADF-STEM images taken near the crystal grain boundary of the ceramic composition 10 shown in FIG. 1. HAADF-STEM refers to high-angle annular dark field scanning transmission electron microscopy. In an HAADF-STEM image, a heavy element appears as a bright area. Through comparison with a structural model, white spots with high brightness are found to correspond to an atomic column of tungsten (W).

An image A in FIG. 3 is an HAADF-STEM image taken near the crystal grain boundary between crystal grains of alumina and crystal grains of tungsten carbide shown in an image B. In the image A in FIG. 3, an alumina layer 20 represents an atomic layer of crystal grains of alumina; WC layer 30 represents an atomic layer of crystal grains of tungsten carbide; and an Hf layer 40 represents an atomic layer originating from a hafnium compound.

As shown in FIG. 3, in the ceramic composition 10, the Hf layer 40 exists between the alumina layer 20 and the WC layer 30. In other words, in the ceramic composition 10, an atomic layer formed of hafnium (Hf) exists at the crystal grain boundary between crystal grains of alumina (Al₂O₃) and crystal grains of tungsten carbide (WC). Further, the Hf layer 40 includes two or more atomic arrangement layers. For example, in the image A shown in FIG. 3, the Hf layer 40 is formed of two atomic arrangement layers of Hf atoms.

Since the Hf layer 40 includes two or more atomic arrangement layers, the Hf layer 40 can form a metal crystal phase of hafnium (Hf). Hafnium (Hf) is an element belonging to the transition metal group and has a hexagonal close-packed metal crystal phase at ambient temperature and pressure. That is, the metal crystal phase of hafnium (Hf) is hexagonal.

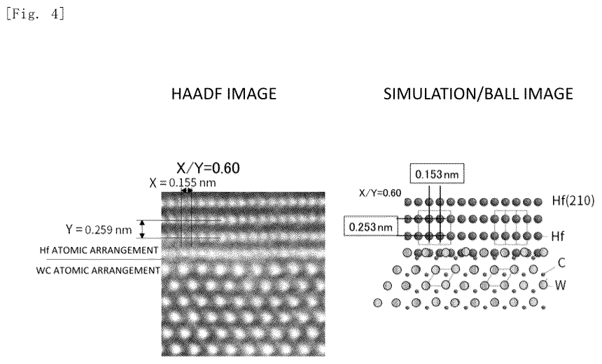

As shown in FIG. 4, the Hf layer 40 is preferably formed of a (210) plane of the metal crystal phase of hafnium (Hf).

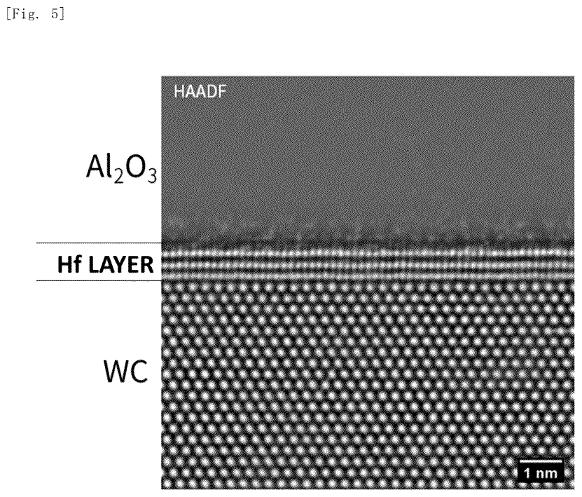

More preferably, as shown in FIG. 5, the Hf layer 40 is formed of the hexagonal (210) plane having a thickness corresponding to three layers thereof.

As described above, when the Hf layer 40 including two or more atomic arrangement layers is present at the crystal grain boundary between crystal grains of alumina and crystal grains of tungsten carbide, the strength in adhesion between crystal grains of alumina and crystal grains of tungsten carbide can be enhanced.

When the Hf layer 40 is formed of a metal crystal phase of hafnium, the yielded ceramic composition can exhibit excellent ductility at high temperature (e.g., 1,400 °C or higher).

### (Pores in Ceramic Composition)

Next, pores present in the ceramic composition 10 will be described. As used herein, the term “pore” refers to vacancy present in the ceramic composition 10 in the form of solid. The pores present in a ceramic component inevitably provided by molding and processing the ceramic composition 10 are also equivalent to cavities.

When the ceramic composition is placed under high-temperature conditions (e.g., 1,400 °C or higher) and application of stress, the pore (or cavity) content of the composition tends to increase. Generally, the ratio gradually increases over time.

Fracture of the ceramic component at high temperature is known to be attributed to generation, growth, and linkage of pores or cavities present in the ceramic composition. When the ceramic composition is processed to a ceramic component having a shape of interest, the pore (or cavity) content of the composition tends to increase by applying stress (e.g., bending processing) to the ceramic composition.

Thus, by suppressing the pore content of the ceramic composition to as low a level as possible, provision of a ceramic composition exhibiting higher performance (specifically, a ceramic composition exhibiting excellent ductility at high temperature) is foreseeable.

The ceramic composition 10 according to the present embodiment preferably has a pore ratio of 0.1% or less, as determined in any one cross-section of the composition. Under the above condition, the yielded ceramic composition exhibits high ductility at high temperature. Notably, the ceramic composition 10 having such characteristics may be produced through the below-mentioned procedure.

The pore ratio can be determined by collecting a plurality of samples from a target ceramic composition or a corresponding ceramic component, and calculating the amount of pores in each sample according to the pore measurement method mentioned below. Among a plurality of samples collected, when a sample has the highest pore ratio of 0.1% or less, there can be confirmed that the target sample has a pore ratio of 0.1% or less.

No particular limitation is imposed on the lower limit of the pore ratio of the ceramic composition 10 according to the present embodiment. It is generally difficult to control the pore ratio to zero (i.e., to confirm the presence of no pore) in a customary ceramic composition containing alumina and tungsten carbide. Thus, the pore ratio of the ceramic composition 10 according to the present invention is greater than 0%.

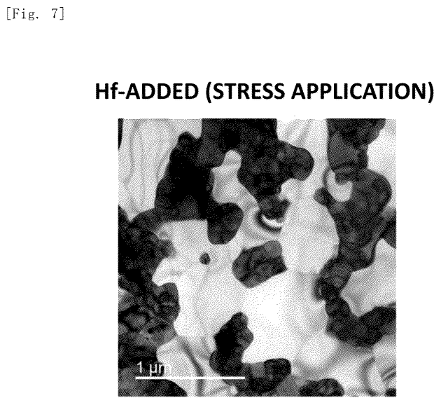

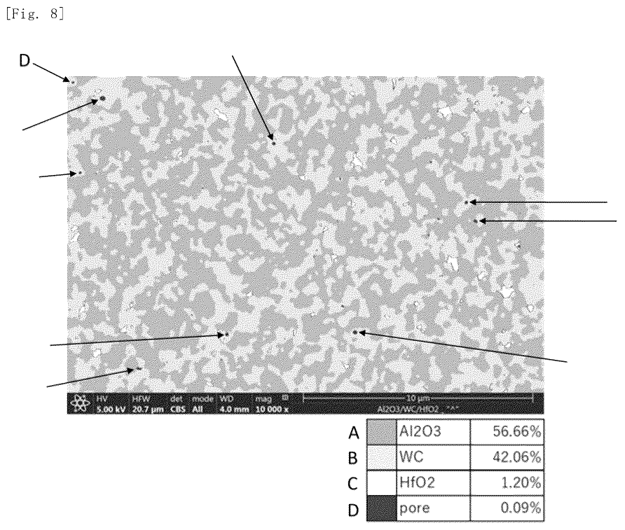

In the ceramic composition 10 according to the present embodiment, a rise in pore ratio can be suppressed even after application of stress (e.g., bending processing) (see FIGS. 7 and 8). FIGS. 7 and 8 show the results of observation of one cross-section of the ceramic composition 10 after application of stress (i.e., after bending test) in a working example.

### (Method of Measuring Pore Ratio)

Next, an example of the method of measuring the ratio of pores present in the ceramic composition 10 will be described.

Firstly, the ceramic composition 10 in a solid state is cut into pieces, and a cross-section selected at random from one of the pieces is polished in an amount of some microns. Then, through vertical cross-section ion milling by use of a shielding plate, the piece is further processed in a depth direction in an amount of 50 μm or more from the polished surface. As a result, an ion-milled cross-section from which polishing damage has been removed is formed, and the cross-section is employed as a surface of observation. As an example of the processing apparatus, an Ar ion milling apparatus (acceleration: 5 to 6 kV) is employed. An area of 300 μm×300 μm or wider is secured as the observation surface.

Subsequently, an SEM image of the observation surface is taken. In one procedure, the observation surface is imaged under an electron microscope at a variable voltage range of 0.1 kV to 20 kV, to thereby obtain image data. The thus-obtained image data are modified in terms of resolution and magnification so as to achieve a resolution (pixel number) 10 times or more the size of the smallest grains in the ceramic structure. Then, the data are stored as a data format without lossy compression (e.g., tiff or bmp).

The thus-obtained image data are subjected to an image analysis. Specifically, the obtained image data are quarternarized by means of an area division function of an image analysis software product (e.g., Avizo Software for Material Research (product of Thermo Fisher Scientific Inc.)). More specifically, quarternarization is conducted in each of the following four regions.
A: region formed of alumina (Al₂O₃)
B: region formed of tungsten carbide (WC)
C: region formed of hafnium (Hf)
D: region corresponding to pores

In the above quarternarization, the grain boundary phase is not taken into consideration, whichever the boundary phase is a homo system or a hetero system. In the case of the homo system, the boundary phase is extracted as a seamless region. Notably, an SEM image is subjected to area division at the uppermost observation surface in consideration of possible overlapping of the image information in the depth direction. Digitization is conducted by utilizing pixel intervals and 2-dimensional calculation function of software, to thereby calculate an area and relative occupancy of each region.

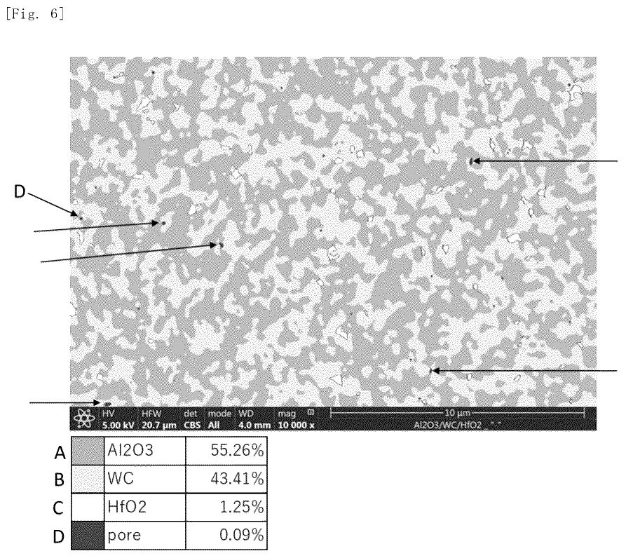

FIG. 6 shows an example of the SEM image of any one cross-section of the ceramic composition 10 after quarternarization through the aforementioned procedure. FIG. 6 also shows the calculated relative occupancy of the above regions A to D, respectively, under the image.

As shown in FIG. 6, the ceramic composition 10 according to the present embodiment has been found to have a pore ratio in any one cross-section of 0.1% or less.

FIG. 8 shows an example of the SEM image of any one cross-section of the stress-applied ceramic composition 10 after quarternarization. FIG. 8 also shows the calculated relative occupancy of the above regions A to D, respectively, under the image.

As shown in FIG. 8, the ceramic composition 10 after application of stress has also been found to have a pore ratio in any one cross-section of 0.1% or less. Thus, in the ceramic composition 10 according to the present embodiment, a rise in pore ratio can be suppressed even after application of stress (e.g., bending processing).

Notably, the above method of measuring pore ratio may also be applied to calculation of the relative amount (vol %) of each ingredient contained in the ceramic composition 10.

In a specific procedure, in the image data individually quarternarized to four regions of the aforementioned A to D, the area of each region is calculated. On the basis of the calculated areas, A/(A+B+C+D), B/(A+B+C+D), and C/(A+B+C+D) are calculated.

Through the above procedure, the relative amount (vol %) of each ingredient in the ceramic composition 10 can be obtained. FIGS. 6 and 8 show the relative amounts of the alumina (Al₂O₃) ingredient, the tungsten carbide (WC) ingredient, and the hafnium (Hf) ingredient contained in the ceramic composition 10.

### (Method for Producing Ceramic Composition)

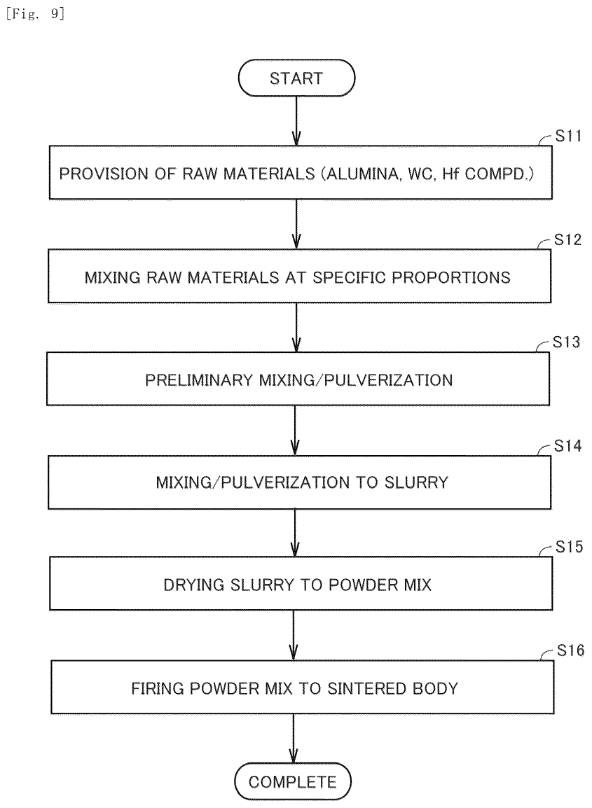

Next, the method of producing the ceramic composition 10 will be described. FIG. 9 shows an example of the method of producing the ceramic composition 10.

Firstly, alumina, tungsten carbide, and a hafnium compound, serving as raw materials of the ceramic composition, are provided in the state of powder (step S11). More specifically, there are used alumina (Al₂O₃) powder having an average particle size of about 0.5 μm, tungsten carbide (WC) powder having an average particle size of about 0.7 μm, and hafnia (HfO₂ ) powder having an average particle size of about 0.4 μm.

The above-described average particle size of the hafnia powder is merely an example. In order to disperse the hafnia powder more uniformly at the interface between alumina crystal grains and tungsten carbide crystal grains, the hafnia powder is preferably in the form of more finely regulated powder. Notably, the average particle size of each powder may be measured by means of a laser diffraction particle size distribution meter.

Next, the thus-provided raw materials are weighed and mixed at specific proportions (step S12). The proportions of mixing the raw materials may be set on the basis of the target proportions (e.g., vol %) of the ingredients in the ceramic composition 10 to be yielded. For example, in the case where the powder raw materials are mixed and then fired to thereby form the ceramic composition 10, the powder raw materials are mixed such that the proportions in the powder raw material mixtures are regulated to achieve target values (vol %). The relative amount (vol %) of each powder raw material may be calculated on the basis of the mass of each powder raw material involved in mixing and the specific weight of the raw material.

Since the raw materials substantially have no reactivity in the production step thereof, the relative amount (vol %) of each ingredient of the ceramic composition 10 can be tuned to a value of interest by regulating the proportions (vol %) of the raw materials involved in mixing. Notably, the relative amount (vol %) of each ingredient in the produced ceramic composition 10 may be determined through the aforementioned method.

Next, preliminary mixing/pulverization is conducted (step S13). In this step, in a preferred mode, a dispersion/mixing treatment in which only hafnia powder is pulverized in advance is conducted. More specifically, hafnia powder is subjected to preliminary crushing by use of a solvent and a ball mill for about 40 hours. Alternatively, particles of hafnia powder may also be pulverized by means of bead mill crushing or the like.

Alternatively, in the preliminary dispersion/mixing treatment step, alumina powder and tungsten carbide powder are mixed with a solvent (e.g., ethanol) by means of a ball mill, to thereby pulverize particles of the powders. The time of the treatment may be shorter than or longer than 20 hours.

Subsequently, mixing/pulverization is conducted to thereby form a slurry (step S14). In a specific procedure, the hafnia powder which has been subjected to preliminary pulverization and a solvent (e.g., ethanol) are added to a mixture of alumina powder and tungsten carbide powder in the ball mill, and mixing and pulverization are further conducted.

Through the above procedure, there can be produced a slurry in which particles of alumina, tungsten carbide, and hafnia are dispersed. In the present embodiment, the time of mixing a mixture of alumina and tungsten carbide with hafnia added, and pulverizing the resultant mixture may be adjusted to about 20 hours. However, the method is not limited to the above procedure, and there may be employed an alternative method in which the above time is shorter than or longer than 20 hours.

Next, the slurry is dried to prepare a powder mixture (step S15). Examples of the method of yielding a powder mixture from the slurry include a method in which the solvent is removed from the slurry by drying while the slurry is heated in a hot bath, to thereby yield a power, which is caused to pass through a sieve.

Finally, the powder mixture is fired via hot pressing, to thereby yield a ceramic composition from the powder mixture (step S16). In the present embodiment, the powder mixture is charged into a mold made of carbon during hot pressing, and the powder mixture is heated while the mixture is monoaxially pressed. As a result, the ceramic composition 10, which is a sintered body of the powder mixture, is yielded.

The conditions of hot pressing in the present embodiment are, for example, as follows. The firing temperature is 1,700 °C or higher and 1,900 °C or lower (preferably 1,800 °C or higher and 1,900 °C or lower, more preferably, 1,880 °C); the firing time is 1 hour or longer and 3 hours or shorter (preferably 2 hours); the pressure is 25 MPa or higher and 35 MPa or lower (preferably, 30 MPa) ; and the atmosphere is argon (Ar). The firing temperature in firing is preferably set to a temperature around the temperature at which a liquid phase of alumina and hafnia is formed. As a result, transfer (diffusion) of a particular element can be promoted.

Through the above production method, the ceramic composition 10 in a solid state can be yielded. In the ceramic composition 10 yielded through the production method, a segregated hafnium layer (i.e., an Hf layer 40) is formed at the crystal grain boundary (i.e., interface) between crystal grains of alumina (Al₂O₃) (i.e., the alumina layer 20) and crystal grains of tungsten carbide (WC) (i.e., the WC layer 30) (see, for example, FIG. 3). Conceivably, by virtue of the above feature, interfacial adhesion can be strengthened, to thereby achieve high-temperature ductile function of the ceramic composition 10.

In other words, the yielded ceramic composition 10 can exhibit consistently high ductility even under high-temperature conditions (about 1,400 °C) and a flexural strength higher than 400 MPa. In addition, the ceramic composition 10 according to the present embodiment can exhibit a low pore ratio (e.g., 0.1% or less) therein even after application of stress.

### (Ceramic Component)

The ceramic component according to the present embodiment includes the ceramic composition 10. The ceramic component may be produced through deformation processing (e.g., cutting, grinding, or polishing) of the ceramic composition 10 having, for example, a rectangular parallelepiped shape shown in FIG. 1, into a specific shape.

Such a produced ceramic component can exhibit consistent performance under high-temperature conditions (e.g., 1,400 °C or higher). Thus, the ceramic composition according to the present embodiment is suitably used as a ceramic component of a device employed under high-temperature conditions. Specific examples of the ceramic component include a gas turbine member, a spray nozzle for use in an artificial satellite, a metal mold for lenses, a sealing material, an aircraft engine member, and a cutting tool.

### Summary of Embodiment

The ceramic composition 10 according to the present embodiment exhibits a more enhanced heat resistance than that of a conventional heat-resistant alloy member employed under high-temperature conditions. Also, the possibility of brittle fracture of the ceramic composition 10 according to the present embodiment is reduced, as compared with a conventional ceramic component employed under high-temperature conditions, resulting in high reliability. By virtue of such characteristic features, the ceramic composition 10 according to the present embodiment can be applied to a component of a device or a system employed under high-temperature conditions (such as aerospace and power generation).

In addition, the mechanical strength of the ceramic composition 10 according to the present embodiment can be maintained during deformation processing. Thus, superplastic deformation processing or joining can be performed, resulting in enhancement in moldability to provide a complex shape and sealability. By virtue of such characteristic features, the ceramic composition can also find uses as a curved lens mold or a sealing material.

As described above, the ceramic composition 10 according to the present embodiment exhibits excellent mechanical strength and ductility under high-temperature conditions and can hopefully exhibit effects various aspects, including prolonged service life and enhanced processability.

### EXAMPLES

The present invention will next be described by way of example, which should not be construed as limiting the invention thereto.

In the Example, the ceramic composition 10 was produced according to the aforementioned production method, and ductility thereof at high temperature was assessed. In Comparative Example, a similar ceramic composition including no Hf layer 40 was also produced, and high-temperature ductility was assessed in the same manner.

### (Raw Materials of Ceramic Composition)

Raw materials of the ceramic composition of Example and that of Comparative Example, and formulations (vol %) thereof were as follows.

### Example

1. Alumina (Al₂O₃) powder (average particle size of 0.5 μm): 55%
2. Tungsten carbide (WC) powder (average particle size of 0.7 μm): 45%
3. Hafnia (HfO₂) powder (average particle size of about 0.4 μm): 1% (formulation (vol %) with respect to the sum of the above main ingredients 1 and 2 as 100%)

### Comparative Example

1. Alumina (Al₂O₃) powder (average particle size of 0.5 μm): 55%
2. Tungsten carbide (WC) powder (average particle size of 0.7 μm): 45%

### (Hot Press Conditions)

In Example and Comparative Example, hot pressing was conducted in production of ceramic compositions under the following conditions.
Firing temperature: 1,880 °C
Firing time: 2 hours
Pressure: 30 MPa
Atmosphere gas: argon (Ar)

### (Assessment of Ductility at High Temperature)

The ceramic compositions according to Example and Comparative Example were subjected to a flexural strength test through the following procedure and under the following conditions, whereby ductility at high temperature was assessed.

### <Flexural Strength Test Method>

Flexural strength of a test piece (total length: 35 mm, width: 4 mm, and thickness: 3 mm) was measured. A tester measured a three-point flexural strength of each of the samples of Example and Comparative Example under the following conditions according to JIS R1601.
Temperature: 1,400 °C
Atmosphere gas: argon (Ar)
Bending rate: 0.5 mm/min
Bending span distance: 30 mm
Tester: Ultra-high temperature material tester, type MST808
Jig material: SiC

### <Results>

The ceramic composition according to the Example was confirmed to have a flexural strength higher than 400 MPa under temperature conditions of 1,400 °C. In contrast, the ceramic composition according to Comparative Example was found to be broken at application of a flexural stress of about 300 MPa at 1,400 °C.

### (HAADF-STEM Images of Ceramic Composition)

FIG. 3 shows HAADF-STEM images of a cross-section of the ceramic composition according to the Example before the bending test. As shown in FIG. 3, the presence of an atomic layer formed of hafnium (Hf) at the crystal grain boundary between crystal grains of alumina (Al₂O₃) and crystal grains of tungsten carbide (WC) was confirmed. In addition, the atomic layer formed of hafnium was found to include two or more atomic arrangement layers of hafnium, and that hafnium (Hf) forms a metal crystal phase.

Notably, in the ceramic composition according to Comparative Example, no hafnium atomic layer was found to be formed at the crystal grain boundary.

### (TEM Images of Ceramic Composition)

FIG. 2 shows a TEM image of a cross-section of the ceramic composition according to the Example, before the flexural test. FIG. 7 shows a TEM image of a cross-section of the ceramic composition according to the Example after the flexural test. The TEM image shown in FIG. 7 is an image of a sample prepared by the same method as employed in the sample of the TEM image shown in FIG. 2 and obtained through observation of the sample.

As shown in FIG. 2, no substantial pore was confirmed to be present in the microstructure of the ceramic composition before the flexural test. In addition, as shown in FIG. 7, no substantial pore (i.e., cavity) was confirmed to be present in the microstructure of ceramic composition after the flexural test.

### (Pore Ratio of Ceramic Composition)

FIG. 6 shows the measurement of the pore ratio of any one cross-section of the ceramic composition according to the Example before the flexural test. Also, FIG. 8 shows the measurement of the pore ratio of any one cross-section of the ceramic composition according to the Example after the flexural test.

As shown in FIGS. 6 and 8, the pore ratio of the ceramic composition according to the Example was confirmed not to be varied before and after the flexural test.

### Summary of Examples

Based on the aforementioned test results, the ceramic composition according to the Example was found to have ductility (resistance to brittle fracture) and exhibit consistent flexural strength of 400 MPa or higher, under very high-temperature conditions (i.e., 1,400 °C or higher).

Also, in the ceramic composition according to the Example, generation of pores under application of stress and high-temperature conditions, which would otherwise occur in a conventional ceramic composition, was found to be successfully suppressed. Conceivably, suppression of pore generation is attributed to enhancement in sliding performance at the interface between alumina crystal grains and tungsten carbide crystal grains evoked by the metallic hafnium layer included in the ceramic composition according to the Example.

The embodiment disclosed herein is given for an illustration purpose and should not be construed as limiting the invention from all aspects. The scope of the present invention is defined not by the above descriptions but by the claims attached. The invention contemplates to encompassing all modifications falling within the claims and the scope of the equivalents thereof. Also, features of different embodiments disclosed in the present specification may be combined to provide a technical feature falling within the scope of the present invention.

### DESCRIPTION OF REFERENCE NUMERALS

10: ceramic composition
20: alumina layer (crystal grains of alumina)
30: WC layer (crystal grains of tungsten carbide)
40: Hf layer (atomic layer formed of hafnium)

1. A ceramic composition comprising alumina (Al₂O₃) and tungsten carbide (WC), wherein
the composition contains an atomic layer formed of hafnium (Hf) existing at a crystal grain boundary between crystal grains of alumina (Al₂O₃) and crystal grains of tungsten carbide (WC), and
the atomic layer includes two or more atomic arrangement layers of hafnium.

2. The ceramic composition according to claim 1, wherein
the ceramic composition has a pore ratio of 0.1% or less, as determined in any one cross-section of the composition.

3. The ceramic composition according to claim 1, wherein
the atomic layer at the crystal grain boundary is formed of a metal crystal phase of hafnium (Hf).

4. The ceramic composition according to claim 3, wherein
the atomic layer at the crystal grain boundary is formed of a (210) plane of the metal crystal phase of hafnium (Hf).

5. The ceramic composition according to claim 4, wherein
the metal crystal phase of hafnium (Hf) is hexagonal, and
the atomic layer is formed of the hexagonal (210) plane having a thickness corresponding to three layers thereof.

6. A ceramic component, comprising a ceramic composition as recited in claim 1.

7. The ceramic component according to claim 6,
which is used as any of a gas turbine member, a spray nozzle for use in an artificial satellite, a metal mold for lenses, a sealing material, an aircraft engine member, and a cutting tool.
